(19) United States
(12) Patent Application Publication
(10) Pub. No.: US 2007/0262689 A1
(43) Pub. Date: Nov. 15, 2007

(54) High pressure discharge lamp

(75) Inventors: Joachim Arndt, Brieselang (DE); Uwe Fidler, Berlin (DE); Markus Herb, Gunzburg (DE); Matthias Lenz, Falkensee (DE)

Correspondence Address: COHEN PONTANI LIEBERMAN & PAVANE LLP, Suite 1210, 551 Fifth Avenue, New York, NY, 10176, US

(73) Assignee: Patent-Treuhand-Gesellschaft fur elektrische Gluhlampen mbH, Munchen (DE)

(21) Appl. No.: 11/731,065

(22) Filed: Mar. 30, 2007

(30) Foreign Application Priority Data
Mar. 30, 2006 (DE) 20 2006 005 158.9

(51) Int. Cl. H01J 5/48

(52) U.S. Cl. 313/318.01

(57) ABSTRACT

A lamp that has a base with a base insulator. Power supply lines are connected in the base to extension wires by means of coils.

### FIELD OF THE INVENTION

The invention is based on a high-pressure discharge lamp with a base at one end and with an inner vessel (2, 3), which is surrounded by an enveloping part (24), a base with electrical terminals bearing, on the one hand, the inner vessel and, on the other hand, the enveloping part. Such lamps are, in particular, high-pressure discharge lamps for general lighting or else for photo-optical purposes.

### BACKGROUND OF THE INVENTION

US-A US2006226754 discloses a high-pressure discharge lamp having a modular design. In this case, the base has a base insulator, from which power supply lines are passed up to the screw thread of the base. In this case, extension wires are generally used which are welded to the power supply lines protruding out of the inner part.

### SUMMARY OF THE INVENTION

One object of the present invention is to provide a high-pressure discharge lamp which can be produced in a simple and reliable manner.

This and other objects are attained in accordance with one aspect of the present invention that includes the following features:

a) the base has a base insulator, which is manufactured from an insulating material and in which the inner vessel is accommodated;

b) the electrical terminals comprise power supply lines and extension wires, which are connected to one another; and

c) at least one extension wire has, for the purpose of mechanically connecting it to a power supply line, one end which is shaped to form a coil and is twisted onto the end of the power supply line.

According to an embodiment of the invention, a mechanical connection is provided between the power supply lines and the extension wires by a simple winding technique. In this case, the extension wire has an open winding. This open winding is drawn over the power supply line in hoisting fashion, and the power supply line is thus connected to the extension wire sufficiently fixedly. Complex tools and connecting machines are not required.

Sufficient electrical contact can be ensured if the extension wire consists of a nickel-containing metal alloy such as Nicorros, for example, and if the power supply line consists of a metal or an alloy selected from the following group:

molybdenum, alloys of molybdenum, iron/copper, etc.

It has been shown that other materials such as copper are less suitable for the extension wire since they do not withstand the high loads, for example during welding operations, although their electrical resistance would be ideally suitable.

With the line pair to be connected, in this case the power supply line and the extension wire, it is necessary to take care that the diameters are matched approximately to one another. For example, the diameter of the power supply line may be 1.7 times the diameter of the extension wire. In absolute terms, the diameters should be of the order of magnitude of from 600 to 1000 μm.

The ratio of the outer diameter AD of the power supply line to the inner diameter ID of the coil on the extension wire in the unspread state can be selected such that a sufficient spring force is effective. This can be achieved at an AD/ID ratio in the range of from 1.1 to 1.3. In the spread state, the coil bears tightly against the power supply line and holds it owing to its spring force.

The invention is suitable for high-pressure discharge lamps in which an inner part rests in an outer part and, in the process, is anchored in a base insulator. Any conventional glass can be used as the material for the bulbs, i.e. in particular hard glass, Vycor or quartz glass. There is also no particular restriction to the choice of filling. Also suitable is the application in reflector lamps, where the reflector consists, in particular, of glass, metal or plastic.

### BRIEF DESCRIPTION OF THE DRAWINGS

FIGS. 1 and 2 show a metal halide lamp in a side view and rotated through 90°;

FIG. 3 shows a detail of a lamp; and

FIG. 4 shows a reflector lamp in a side view.

### DETAILED DESCRIPTION OF THE DRAWINGS

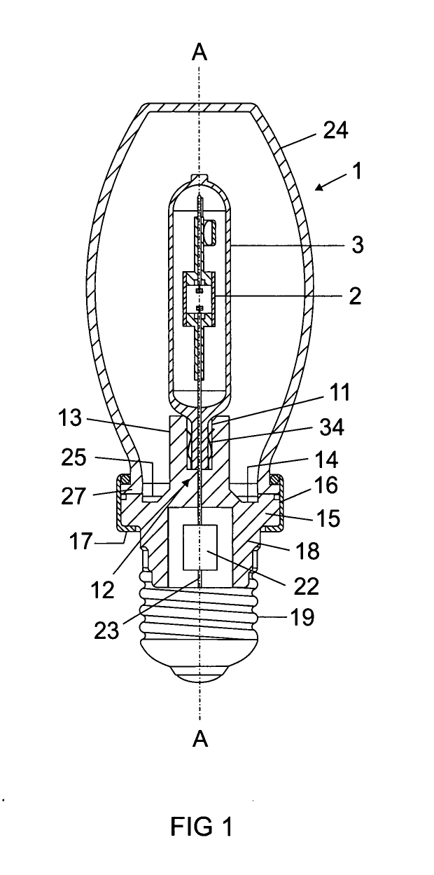

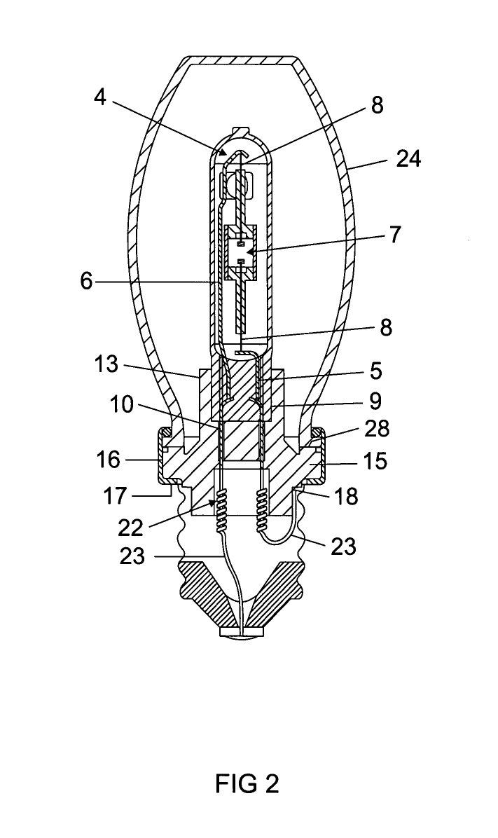

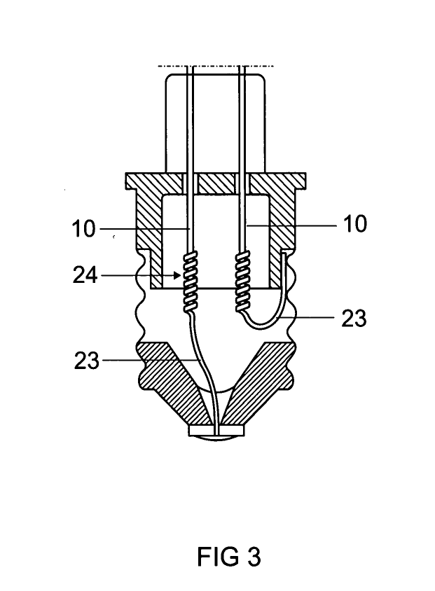

FIGS. 1 and 2 show an exemplary embodiment of a metal halide lamp 1, in each case rotated through 90° with respect to one another. A ceramic discharge vessel 2, which is sealed at two ends, is arranged so as to stretch longitudinally in the lamp axis A. It is tightly surrounded by an outer bulb 3, which has a pinch seal at one end and is manufactured from quartz glass. Both parts 2, 3 together form the inner vessel (2, 3). A frame 4 having a short and a long feed line 5, 6 holds the discharge vessel 2 in the outer bulb 3. The electrodes 7 in the interior of the discharge vessel are connected to the feed lines 5, 6 via leadthroughs 8. Said feed lines are connected to external power supply lines 10 in the region of a pinch seal 9, which seals the outer bulb 3. The pinch seal 9 of the outer bulb rests in an opening 11, which fits said pinch seal, in a base insulator 12 consisting of ceramic and is held there by a metal clip 34. The base is essentially formed from the base insulator 12 and a screw base part 19. This opening 11 is surrounded by a central collar part 13. It protrudes out of a plane which forms the upper plateau 14 of a radially protruding, disk-shaped segment 15. The segment 15 is furthermore designed to have a side wall 16 and a lower plateau 17. It rests on a neck part 18, which holds a part associated with the lampholder, in this case a screw base part 19 with a thread. The screw base 19 is fixed to the neck part 18 by means of crimping 20. The neck part 18 is hollow on the inside, the power supply lines 10 being connected to electrical terminals 23 of the base via a mechanical connection 22 in the cavity of the neck part. This is shown in detail in FIG. 3.

An enveloping bulb 24, which surrounds the outer bulb 3 at a relatively great distance, has a base-side opening 25, which is circular-cylindrical and is matched in terms of diameter to the outer diameter of the segment 15.

The enveloping bulb 24 is equipped at its opening 25 with a radially protruding edge 27. It has a flat, lower contact face 28, which is matched to the upper plateau 14 of the segment of the base insulator.

FIG. 3 shows, in detail, the connection between the power supply line and the extension wire. In this case, the power supply line 10 consists of molybdenum having a diameter of 0.8 mm, and the extension wire 23 consists of Nicorros having a diameter of 0.6 mm. The end of the extension wire is wound to form a coil 24, having approximately 5 turns. The coil is drawn over the power supply line in twisting fashion. The direction of twist in this case needs to be selected to be counter to the winding direction of the coil, with the result that the coil opens easily when twisted. In this case, the inner diameter of the coil is initially from 10 to 20% smaller than the diameter of the power supply line and expands when it is drawn over to such an extent that it bears tightly and in a force-fitting manner against the power supply line.

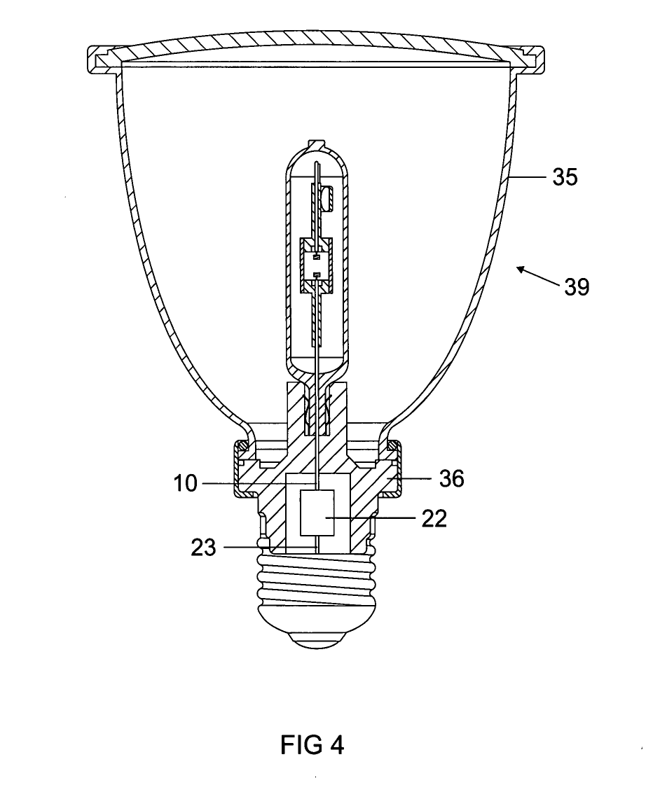

FIG. 4 shows a reflector lamp 39 having such a connection. The reflector 35 rests on the base insulator 36. The connection 22 rests between the power supply line 10 and the extension wire 23.

We claim:

1. An electric lamp comprising:
an inner vessel;
an enveloping part surrounding said inner vessel;
a base at one end of the electric lamp with electrical terminals bearing, on the one hand, the inner vessel and, on the other hand, the enveloping part;
wherein said base has a base insulator, which is manufactured from an insulating material and in which the inner vessel is accommodated;
wherein the electrical terminals comprise power supply lines and extension wires, which are connected to one another; and
wherein at least one extension wire has, for the purpose of mechanically connecting it to a power supply line, one end which is shaped to form a coil and is twisted onto the end of the power supply line.

2. The electric lamp as claimed in claim 1, wherein the material of the extension wire is a nickel-containing alloy.

3. The electric lamp as claimed in claim 1, wherein the coil comprises at least 1.5 turns.

4. The electric lamp as claimed in claim 1, wherein the diameter of the power supply line has a ratio of 1.25 to 2.0 with respect to the diameter of the extension wire.

5. The electric lamp as claimed in claim 1, wherein the enveloping part is an outer bulb or a reflector.

6. The electric lamp as claimed in claim 1, wherein the diameter of the power supply line has a ratio of 1.1 to 1.3 with respect to the inner diameter of the coil in the unspread state.
